(19) United States
(12) Patent Application Publication
(10) Pub. No.: US 2020/0118774 A1
(43) Pub. Date: Apr. 16, 2020

(54) Rotary Switch Suitable For Use In Adverse Environmental Conditions

(71) Applicant: ROTORK INSTRUMENTS ITALY S.R.L., Cusago (IT)

(72) Inventor: Marco Beltrami, Castel Mella (IT)

(21) Appl. No.: 16/713,352

(22) Filed: Dec. 13, 2019

Related U.S. Application Data
(63) Continuation of application No. 15/350,106, filed on Nov. 14, 2016.

(30) Foreign Application Priority Data
Nov. 12, 2015 (IT) 102015000071969

(51) Int. Cl. H01H 19/06; H01H 19/11; H01H 13/06; H01H 11/00; H01H 19/04

(52) U.S. Cl. CPC H01H 19/06; H01H 19/11; H01H 13/06; H01H 11/00; H01H 2219/028; H01H 2239/034; H01H 2229/00; H01H 2223/008; H01H 19/04

(57) ABSTRACT

A rotary switch fitted with signalling means to provide a visual indication of the operating condition of an actuator device, comprising a switch body made of metal or coated externally in metal and a cover is provided. The cover may be joined to close the switch body by means of a plurality of attachment screws in metal or externally coated in metal, each housed in seats arranged in the cover and in the switch body. In particular, inside the seat of the switch body there may be an insert made of a material suitable to prevent the circulation of galvanic currents between the seat of the switch body and the attachment screw.

### CROSS-REFERENCE TO RELATED APPLICATIONS

This application is a continuation of U.S. patent application Ser. No. 15/350,106 filed Nov. 14, 2016, which claims priority to Italian Patent Application No. 102015000071969, filed Nov. 12, 2015, the disclosures of each of which are hereby incorporated by reference in their entireties.

### DESCRIPTION

The present invention relates to a rotary switch, provided with visual signalling means, particularly suitable for use in adverse environmental conditions.

In particular, a rotary switch is provided with signalling means, such as a status indicator, to provide a visual indication of the operating condition of an actuator device, such as a valve or an actuator, operatively connected to said switch. A rotary switch of this type, fitted with a visual signalling means, is commonly referred to as a ‘limit switch box’, hereinafter called, for brevity, LSB.

The LSB switches of the prior art, are usually composed of a body and a cover and contain inside them a rotating member or indicator operatively connected to the shaft of the valve or actuator contained in the body. The rotating members are often equipped with visual indicators of the angular position of the shaft of the valve or actuator, in order to provide, from outside the switch, a visual indication of the operating condition of the valve or actuator. These visual indicators are usually housed on the cover so as to be visible from outside the switch, for example the indicator is typically a disk or cap, integral in rotation with the shaft and provided with a relative mask: the mask is fixed and acts as a fixed reference for the angular position of the indicator.

LSB switches are often used in the extraction and processing industry of hydrocarbons, such as in oil wells, offshore platforms and pipelines. In such types of installation the presence of a high content of carbon dioxide and hydrogen sulphide in the crude oil and gas, combined with harsh environmental conditions (such as in the open sea or in the desert) can give rise to serious corrosion phenomena.

A typical example is corrosion by galvanic contact, which occurs when one metal is in electrical contact with another more noble metal (in actual fact mere mechanical metal-to-metal contact is often enough) and both are exposed to a harsh environment (for example, in presence of sea water or acidic solutions). Such corrosion has as a consequence the slow and progressive oxidation of the less noble material. Moreover, in the case of the combined action of mechanical stress in a corrosive environment, phenomena are often triggered involving the propagation of cracks in the metal which may lead to the piece breaking.

Even LSB switches, which are mainly made of metal, when used in adverse environmental conditions are subject to these types of corrosion which then damage or break them. This causes high costs to be incurred related to direct damage (damaged materials that need to be replaced, replacement operations) and indirect damage (loss of production, downtime of the plant, pollution).

As a result, the need is felt in the sector of industries operating in harsh environments to have available highly reliable products which give rise to low maintenance costs.

The need is therefore felt to provide a rotary switch resistant to corrosion.

Such purpose is achieved by a rotary switch made according to claim 1 and by the relative production method according to claim 9.

Other embodiments of the switch according to the invention are described in the subsequent claims.

Further characteristics and advantages of the present invention will be more clearly comprehensible from the description given below of a preferred and non-limiting example of embodiment, wherein:

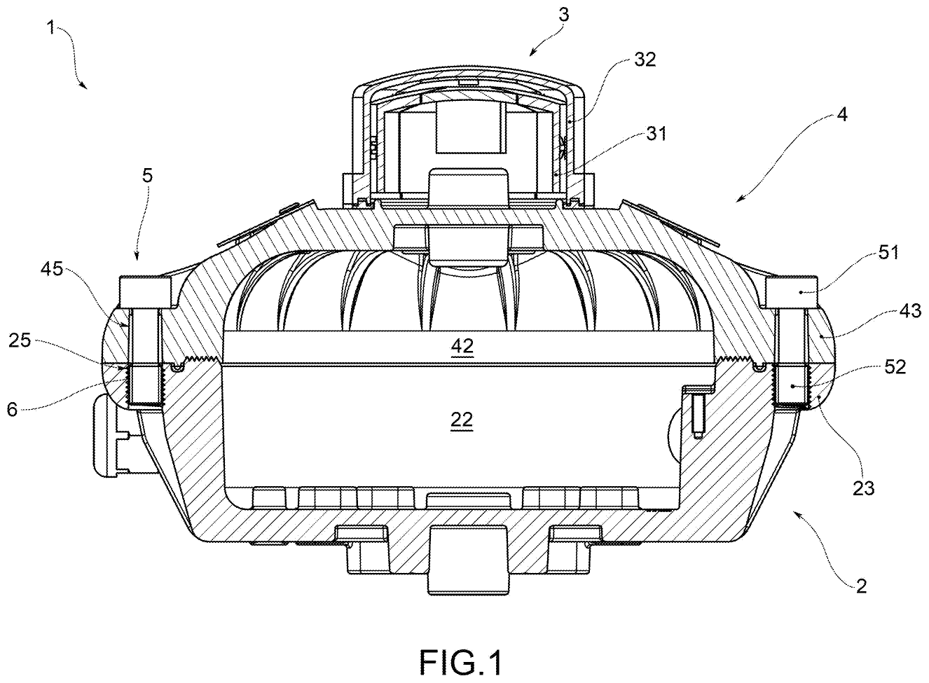

FIG. 1 is a side view in cross-section of a rotary switch according to the present invention;

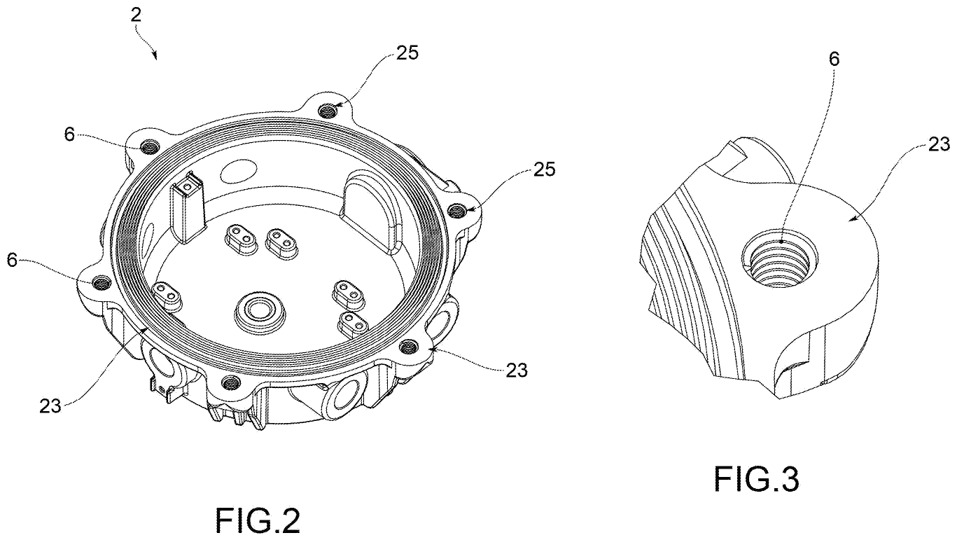

FIG. 2 is a perspective view of the body of the rotary switch in FIG. 1;

FIG. 3 is a detail of the body in FIG. 2;

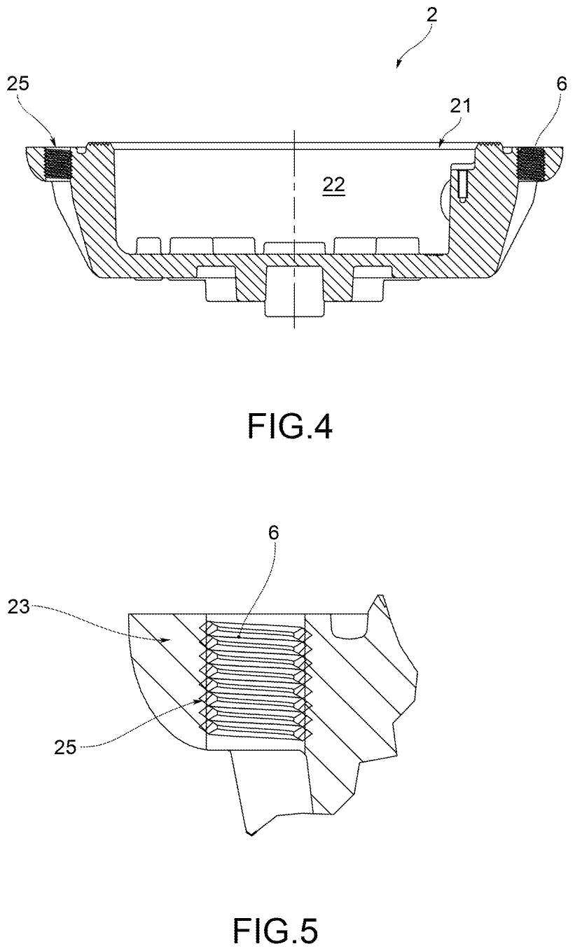

FIG. 4 is a side view in cross-section of the body in FIG. 2;

FIG. 5 is a detail of the body in FIG. 5.

With reference to the aforementioned figures, reference numeral 1 globally denotes a rotary switch, fitted with visual signalling means for providing a visual indication of the operating condition of an external device.

The rotary switch 1 comprises a switch body 2 which rotatably houses a shaft (not shown), rotating around a rotation axis X-X, based on the operation of the external device.

The switch body 2 is made of metal or externally coated in metal. For example, the switch body 2 is made of aluminium or aluminium alloys.

The shape, number of walls and the geometric dimensions of the switch body 2 may be of any type and should not in any way be regarded as limiting for the purposes of the present invention.

The switch body 2 comprises an opening 21 for access to the internal compartment 22 in which the shaft is rotatably housed.

The switch body 2 comprises, at the opening 21, an edge 23 protruding outwards.

The rotary switch 1 comprises a cover 4, joined to close the switch body 2, and fitted with visual signalling means 3 rotatably connected to the rotary shaft about the axis of rotation X-X.

Preferably, the cover 4 is made of metal or is externally coated in metal.

The cover 4 comprises an opening for access to the internal compartment 42 in which the shaft is rotatably housed.

The cover 4 comprises, at the opening 21, an edge 43 protruding outwards.

Preferably, the visual signalling means 3 comprise an indicator 31 joined in rotation to said shaft 20, so as to permit a visual signalling of the angular position and/or operating condition of the rotating shaft, from outside the rotary switch 1.

According to one embodiment, the indicator 31 is rotatable around said rotation axis X-X, and may be provided with a cover 32 to allow the visual signalling of the state of operation of the external device. For example, the cover 32 acts as a mask so as to permit a rapid and effective identification of the state of operation of the external device; for example the cover 32 comprises masked areas and the indicator 31 comprises operating signals, such as the wording ‘open-close’.

Indications of the operating status of the external device are shown on the indicator 31, operatively connected to the shaft, said indications being shown by mechanical, chemical, electrochemical procedures or by the affixing of labels.

The cover 4 is joined to close the switch body 2 by means of a plurality of attachment screws 5, each housed in a special seat 45,25 provided simultaneously in the cover 4 and in the switch body 2;

The switch body 2 preferably comprises at the edge 23, a plurality of seats 25. The cover 4 also preferably comprises, at the edge 43, a plurality of seats 45 arranged in correspondence with the seats 25 of the switch body 2.

The seat 25 made in the switch body 2 is a nut screw, i.e. a threaded hole. Preferably, the seat 25 is a through threaded hole.

Preferably, the seat 45 made in the cover 4 is a threaded through hole in the first section to make the screw captive.

The attachment screws 5 are made of metal or externally coated in metal. For example, the attachment screws 5 are made of steel, preferably stainless steel.

The attachment screw 5 comprises a head 51 and a threaded end portion 52. Preferably, the attachment screws 5 are coach screws.

Even in the conventional rotary switches, the cover is joined to close the switch body by means of a plurality of screws. It is to be noted that the body and the screws are made of different metal materials, and in particular the body is usually made of less noble metal. Therefore, when the conventional rotary switch is used in adverse environmental conditions and thus exposed to a harsh environment, the mere mechanical metal-to-metal contact between the body and screws triggers corrosion by galvanic contact. Such corrosion leads to the formation of rust which seals the screw to the nut screw and prevents the opening of the conventional rotary switch for performing maintenance operations. Furthermore, the corrosion combined with the mechanical stresses due to screwing of the screws into the body triggers propagation of the cracks in the metal which leads to breaking of the conventional rotary switch.

As a result, advantageously, the rotary switch 1 according to the present invention provides for the insertion, inside the seat 25 made in the switch body 2, of an insert 6.

The insert 6 is a cylindrical element (for example a bushing) threaded externally to engage in the nut screw of the seat 25, and internally to receive the attachment screw 5 which engages in its thread.

Advantageously—the insert 6 is made of a material suitable to prevent the occurrence of galvanic currents between the seat 25 of the switch body 2 and the attachment screw 5.

In one embodiment, the insert 6 is made of the same metal material as the attachment screw 5: consequently between the insert and the screw no corrosive phenomena are triggered. In this example, the insert 6 is made of more noble metal with respect to the switch body 2: therefore between the body and the insert corrosion phenomena could be triggered. However, the possible formation of oxide between the body and the insert, which further seals said two elements does not interfere with the rotary switch 1 according to the present invention for carrying out maintenance operations. In this embodiment, the insert 6 makes it possible to shift the corrosive phenomenon from the body-screw to the body-insert.

In the embodiment in which the switch body 2 is made of aluminium or aluminium alloys and the attachment screw 5 is made of steel, the insert 6 is for example made of steel, preferably stainless steel.

In a further embodiment, the insert 6 is made of insulating material or coated in insulating material: consequently between the insert and the screw no corrosive phenomena are triggered. This way it is possible to prevent the circulation of micro-currents and prevent the corrosion of the less noble of the two metals. In this example therefore, the insert 6 is able to electrically isolate the two metals and prevent any circulation of current between them. The insert 6 thus makes it possible to prevent any corrosion phenomenon between body-insert and insert-screw.

In the embodiment in which the switch body 2 is made of aluminium or aluminium alloys and the attachment screw 5 is made of steel, the insert 6 is for example made of steel coated in insulating material or charged plastic.

The present invention also relates to a production method of a rotary switch 1 fitted with a cover 4 joined to close the switch body 2 by means of a plurality of attachment screws 5, each housed in a special seat 45,25 provided in the cover 4 and in the switch body 2. In particular, the method provides for:
providing a switch body 2 made of metal or externally coated in metal;
making a seat 25 in the switch body 2;
inserting inside the seat 25 an insert 6 made of a material suitable to prevent the occurrence of galvanic currents between the seat 25 of the switch body 2 and the attachment screw 5.

In particular the step of making a seat 25 provides for making a nut screw in the switch body 2 and the step of inserting the insert 6 provides for screwing the insert 6, threaded both internally and externally, into the nut screw.

Innovatively, a rotary switch 1 according to the present invention is corrosion-resistant and particularly suitable for use in adverse environments (such as oil platforms in the open sea or oil wells in the desert).

Advantageously, a rotary switch 1 according to the present invention, provided with an insert 6 between the nut screw of the seat 25 of the switch body 2 and the attachment screw 5, is not subject to the occurrence of corrosive events between body and screw.

A person skilled in the art may make numerous modifications and variations to the rotary switch described above so as to satisfy contingent and specific requirements while remaining within the sphere of protection of the invention as defined by the following claims.

1. A limit switch box comprising:
a body made from or coated externally with a first metal, the body comprising a plurality of seats arranged around the periphery of the body;
a body cover removably attached to the body to define an internal compartment, the body cover defining a corresponding plurality of through-holes arranged around the periphery of the cover;
a plurality of screws made from or coated externally with a second metal that is different to the first metal, each screw being received through a respective through-hole and into a respective seat;
a plurality of inserts made from the second metal, each insert being engaged between a respective seat and a screw received in the seat to prevent direct contact between the seat and the screw;
a rotary switch shaft rotatable relative to the body, wherein the rotary switch shaft extends into the internal compartment and through the body cover;
an indicator provided externally on the body cover, the indicator comprising a rotary member joined to the rotary switch shaft; and
an indicator cover provided over the indicator, the indicator cover comprising masked areas fixed relative to the body to give a fixed point of reference for the angular position of the rotary member.

2. The limit switch box according to claim 1, wherein the second metal is more noble than the first metal.

3. The limit switch box according to claim 1, wherein the first metal is aluminum.

4. The limit switch box according to claim 1, wherein the first metal is an aluminum alloy.

5. The limit switch box according to claim 1, wherein the second metal is steel.

6. The limit switch box according to claim 1, wherein the second metal is stainless steel.

7. The limit switch box according to claim 1, wherein each seat defines a threaded hole, each insert comprises an external thread engaged with a respective seat and each insert comprises an internal thread engaged with a screw received in the seat.

8. A limit switch box comprising:
a body made from or coated externally with a first metal, the body comprising a plurality of seats arranged around the periphery of the body;
a body cover removably attached to the body to define an internal compartment, the body cover defining a corresponding plurality of through-holes arranged around the periphery of the cover;
a plurality of screws made from or coated externally with a second metal that is different to the first metal, each screw being received through a respective through-hole and into a respective seat;
a plurality of inserts made from or coated with an insulating material, each insert being engaged between a respective seat and a screw received in the seat to prevent direct contact between the seat and the screw;
a rotary switch shaft rotatable relative to the body, wherein the rotary switch shaft extends into the internal compartment and through the body cover;
an indicator provided externally on the body cover, the indicator comprising a rotary member joined to the rotary switch shaft; and
an indicator cover provided over the member, the indicator cover comprising masked areas fixed relative to the body to give a fixed point of reference for the angular position of the rotary member.

9. The limit switch box according to claim 8, wherein the insulating material is plastic.

10. The limit switch box according to claim 9, wherein the insulating material is a charged plastic.

11. The limit switch box according to claim 8, wherein the first metal is aluminum.

12. The limit switch box according to claim 8, wherein the first metal is an aluminum alloy.

13. The limit switch box according to claim 8, wherein each insert is made from steel coated with the insulating material.

14. The limit switch box according to claim 8, wherein each seat defines a threaded hole, each insert comprises an external thread engaged with a respective seat and each insert comprises an internal thread engaged with a screw received in the seat.

15. A limit switch box comprising:
a body made from or coated externally with aluminum, the body comprising a plurality of seats arranged around the periphery of the body;
a body cover removably attached to the body to define an internal compartment, the body cover defining a corresponding plurality of through-holes arranged around the periphery of the cover;
a plurality of screws made from or coated externally with stainless steel, each screw being received through a respective through-hole and into a respective seat;
a plurality of inserts made from stainless steel, each insert being engaged between a respective seat and a screw received in the seat to prevent direct contact between the seat and the screw;
a rotary switch shaft rotatable relative to the body, wherein the rotary switch shaft extends into the internal compartment and through the body cover;
an indicator provided externally on the body cover, the indicator comprising a rotary member joined to the rotary switch shaft; and
an indicator cover provided over the member, the indicator cover comprising masked areas fixed relative to the body to give a fixed point of reference for the angular position of the rotary member.
